(19) United States
(12) Patent Application Publication
(10) Pub. No.: US 2025/0324284 A1
(43) Pub. Date: Oct. 16, 2025

(54) INTERFERENCE DIFFERENTIATION

(71) Applicant: QUALCOMM Incorporated, San Diego, CA (US)

(72) Inventors: Dishant SRIVASTAVA, Bangalore (IN); Kumar Rahul TIWARI, Varanasi (IN); Vishwas NARAYANASWAMY, TUMKUR (IN); Srinath ANANTHASWAMY, Basavanagar (IN)

(21) Appl. No.: 18/631,674

(22) Filed: Apr. 10, 2024

(51) Int. Cl. H04W 24/02; H04W 72/541

(52) U.S. Cl. CPC H04W 24/02; H04W 72/541

(57) ABSTRACT

Various aspects of the present disclosure generally relate to wireless communication. In some aspects, a peripheral device may receive a signal experiencing interference. The peripheral device may transmit a suggestion for an adjustment to transmission of the signal based at least in part on a determination of whether the interference is duty-cycled or saturated. Numerous other aspects are described.

### FIELD OF THE DISCLOSURE

Aspects of the present disclosure generally relate to wireless communication and to techniques and apparatuses associated with differentiating interference affecting peripheral device connections.

### BACKGROUND

A wireless personal area network (WPAN) is a short-range wireless network typically established by a user to interconnect various personal devices, sensors, and/or appliances located within a certain distance or area of the user. For example, a WPAN based on a communication protocol such as a Bluetooth® (BT) protocol, a Bluetooth Low Energy (BLE) protocol, or a Zigbee® protocol may provide wireless connectivity to peripheral devices that are within a specific distance (e.g., 5 meters, 10 meters, 20 meters, 100 meters) of each other. Bluetooth is a short-range wireless communication protocol that supports a WPAN between a central device (such as a host device or a source device) and at least one peripheral device (such as a client device or a sink device). However, power consumption associated with Bluetooth communications that operate on a basic rate (BR) and/or enhanced data rate (EDR) physical layer may render WPAN communication impractical in certain applications.

Accordingly, to address the power consumption challenges associated with Bluetooth BR/EDR (sometimes referred to as a Bluetooth classic or Bluetooth legacy protocol), BLE (also referred to herein as WPAN LE) was developed and adopted in various applications in which data transfers are relatively infrequent and/or to enable WPAN communication with low power consumption. For example, BLE exploits infrequent data transfer by using a low duty cycle operation and placing one or both of the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE-enabled smartphones, tablets, laptops, earbuds, or the like. While traditional (or classic) Bluetooth and BLE offer certain advantages, there exists a need for further improvements in Bluetooth and BLE technology. For example, traditional Bluetooth and BLE have a limited range, have a limited data capacity throughput, and are susceptible to interference from other devices communicating in the same frequency band (such as via wireless local area network (WLAN) communications).

### SUMMARY

Some aspects described herein relate to a method of wireless communication performed by a peripheral device. The method may include receiving a signal experiencing interference. The method may include transmitting a suggestion for an adjustment to transmission of the signal based at least in part on a determination of whether the interference is duty-cycled or saturated.

Some aspects described herein relate to a method of wireless communication performed by a central device. The method may include receiving a suggestion for an adjustment to transmission of a signal, the suggestion being associated with a determination of whether interference affecting the signal is duty-cycled or saturated. The method may include applying the adjustment to the transmission of the signal.

Some aspects described herein relate to an apparatus for wireless communication at a peripheral device. The apparatus may include one or more memories and one or more processors coupled to the one or more memories. The one or more processors may be individually or collectively configured to receive a signal experiencing interference. The one or more processors may be individually or collectively configured to transmit a suggestion for an adjustment to transmission of the signal based at least in part on a determination of whether the interference is duty-cycled or saturated.

Some aspects described herein relate to an apparatus for wireless communication at a central device. The apparatus may include one or more memories and one or more processors coupled to the one or more memories. The one or more processors may be individually or collectively configured to receive a suggestion for an adjustment to transmission of a signal, the suggestion being associated with a determination of whether interference affecting the signal is duty-cycled or saturated. The one or more processors may be individually or collectively configured to apply the adjustment to the transmission of the signal.

Some aspects described herein relate to a non-transitory computer-readable medium that stores a set of instructions for wireless communication by a peripheral device. The set of instructions, when executed by one or more processors of the peripheral device, may cause the peripheral device to receive a signal experiencing interference. The set of instructions, when executed by one or more processors of the peripheral device, may cause the peripheral device to transmit a suggestion for an adjustment to transmission of the signal based at least in part on a determination of whether the interference is duty-cycled or saturated.

Some aspects described herein relate to a non-transitory computer-readable medium that stores a set of instructions for wireless communication by a central device. The set of instructions, when executed by one or more processors of the central device, may cause the central device to receive a suggestion for an adjustment to transmission of a signal, the suggestion being associated with a determination of whether interference affecting the signal is duty-cycled or saturated. The set of instructions, when executed by one or more processors of the central device, may cause the central device to apply the adjustment to the transmission of the signal.

Some aspects described herein relate to an apparatus for wireless communication. The apparatus may include means for receiving a signal experiencing interference. The apparatus may include means for transmitting a suggestion for an adjustment to transmission of the signal based at least in part on a determination of whether the interference is duty-cycled or saturated.

Some aspects described herein relate to an apparatus for wireless communication. The apparatus may include means for receiving a suggestion for an adjustment to transmission of a signal, the suggestion being associated with a determination of whether interference affecting the signal is duty-cycled or saturated. The apparatus may include means for applying the adjustment to the transmission of the signal.

Aspects generally include a method, apparatus, system, computer program product, non-transitory computer-readable medium, user equipment, base station, network entity, network node, central device, peripheral device, wireless communication device, access point, mobile station, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless personal area network (WPAN), in accordance with the present disclosure.

FIG. 2 is a diagram illustrating an example of a wireless communication device, in accordance with the present disclosure.

FIG. 3 is a diagram illustrating an example of a protocol stack, in accordance with the present disclosure.

FIG. 4 is a diagram illustrating an example transmission of a data packet from a wireless communication device to a peripheral device over a WPAN connection, in accordance with the present disclosure.

FIG. 5 is a diagram illustrating an example of a wireless communication device, in accordance with the present disclosure.

FIG. 6 is a diagram illustrating an example of audio streams, in accordance with the present disclosure.

FIG. 7 is a diagram illustrating an example of types of interference, in accordance with the present disclosure.

FIG. 8 is a diagram illustrating an example of interference differentiation, in accordance with the present disclosure.

FIG. 9 is a diagram illustrating an example of making an adjustment based on differentiating interference, in accordance with the present disclosure.

FIG. 10 is a diagram illustrating an example process performed, for example, at a peripheral device or an apparatus of a peripheral device, in accordance with the present disclosure.

FIG. 11 is a diagram illustrating an example process performed, for example, at a central device or an apparatus of a central device, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

In a wireless personal area network (WPAN), such as a Bluetooth® (BT) network or a Bluetooth® Low Energy (BLE) network, wireless audio may stream from a central device (e.g., a handset, a smartphone) to multiple peripheral devices (e.g., a left earbud and a right earbud). A primary earbud may receive packets from a central device, such as a user equipment (UE), in a stream directed to the primary earbud. A secondary earbud, paired with the primary earbud, may receive its own stream or receive relayed packets from the primary earbud. In this way, stereo or spatial audio may be provided by the earbuds.

However, earbud links may suffer interference in some frequency spectrums from other devices, such as a Wi-Fi access point, that are in proximity to the earbuds. Earbuds are responsible for indicating the preference of BT packets to the central device/audio source via a channel quality driven data rate (CQDDR) scheme.

As part of the CQDDR scheme, the packet size is selected based on a received signal strength indicator (RSSI) over the BT network, according to channel conditions. Some peripheral devices start with a preference of 3 megabits per second (Mbps) and a packet size of 5 slots, but request to switch to another packet size if a packet error rate (PER) increases. However, in an almost saturated Wi-Fi environment, a single packet may take 50-60 milliseconds (ms) to be successfully transmitted because of retransmissions due to the interference. The packet size and type does not matter as much beyond a certain level of interference. Saturated interference beyond a certain level affects both long and short packets equally.

There is a scenario in which the Wi-Fi interference is not saturated but is duty-cycled (Wi-Fi traffic is moderate). It may be beneficial to use smaller packets, because the smaller packets may have a better chance than longer packets of passing through the duty-cycled interference. However, the central device is not aware of this opportunity and does not account for whether the interference is saturated or duty-cycled.

Various aspects relate generally to BT communications. Some aspects more specifically relate to a peripheral device that may differentiate between saturated interference and duty-cycled interference for better packet selection. The peripheral device may receive a signal experiencing interference and determine whether the interference is saturated or duty-cycled. The peripheral device may transmit a suggestion to a central device for an adjustment to the transmission based at least in part on the determination.

In an example, the peripheral device may differentiate between saturated interference and duty-cycled interference by identifying a difference between a peak value (peak RSSI value) and an average value (average RSSI value) of measurements of the signal. The peripheral device may determine that the interference is duty-cycled if the difference satisfies a difference threshold (e.g., minimum RSSI value difference). Because duty-cycled interference is at a certain level for part of the time and well below that level for another part of the time, the average value is lower over time for duty-cycled interference. The peripheral device may determine that the interference is saturated if the difference does not satisfy the difference threshold (e.g., peak value and average value match or almost match).

Particular aspects of the subject matter described in this disclosure can be implemented to realize one or more of the following potential advantages. By differentiating between saturated interference and duty-cycled interference, the peripheral device may suggest an adjustment to transmission of the signal that improves throughput.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

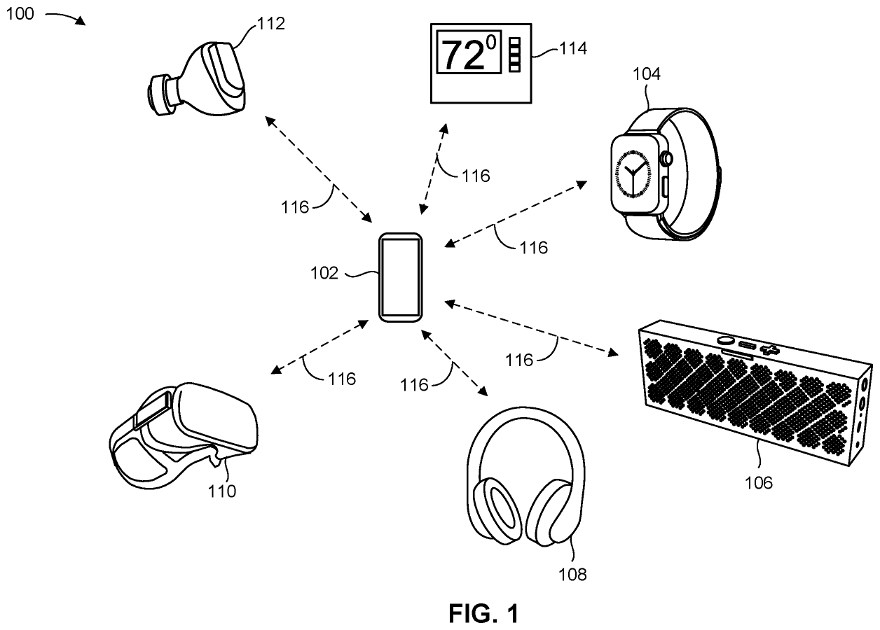

FIG. 1 is a diagram illustrating an example of a WPAN 100, according to some implementations. Within the WPAN 100, a central device 102 (which may be referred to herein as a source device or using other suitable terminology) may connect to and may establish a communication link 116 with one or more peripheral devices, such as a smartwatch 104, a Bluetooth portable speaker 106, wireless headphones 108, an extended reality (XR) headset 110, a wireless earbud 112, and/or a smart appliance 114 (which may be referred to herein as sink devices or using other suitable terminology) using a BLE protocol or a modified BLE protocol. The BLE protocol is part of the BT core specification and enables radio frequency communication operating within the globally accepted 2.4 GHz Industrial, Scientific, and Medical (ISM) band.

In some aspects, as described herein, the central device 102 may include suitable logic, circuitry, interfaces, processors, and/or code that may be used to communicate with the one or more peripheral devices 104, 106, 108, 110, 112, and/or 114 using the BLE protocol or the modified BLE protocol. In some aspects, the central device 102 may operate as an initiator to request establishment of a link layer (LL) connection with an intended peripheral device 104, 106, 108, 110, 112, and/or 114. In some aspects, a link manager may be used to control operations between a WPAN application controller in the central device 102 and a WPAN application controller in each of the intended peripheral devices 104, 106, 108, 110, 112, and/or 114.

In some aspects, after a requested LL connection is established, the central device 102 may become a host device, and the selected or intended peripheral device 104, 106, 108, 110, 112, and/or 114 may become paired with the central device 102 over the established LL connection. As a host device, the central device 102 may support multiple concurrent LL connections with various peripheral devices 104, 106, 108, 110, 112, and/or 114 that are operating as client devices. For example, the central device 102 may manage various aspects of data packet communication in an LL connection with one or more associated peripheral devices 104, 106, 108, 110, 112, and/or 114. For example, the central device 102 may determine an operation schedule in the LL connection with one or more peripheral devices 104, 106, 108, 110, 112, and/or 114. The central device 102 may also initiate an LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, and/or 114 may take place within connection events.

In some aspects, the central device 102 may be configured to transmit the first LL data PDU in each connection event to an intended peripheral device 104, 106, 108, 110, 112, and/or 114. Additionally, or alternatively, in some aspects, the central device 102 may utilize a polling scheme to poll the intended peripheral device 104, 106, 108, 110, 112, and/or 114 for an LL data PDU transmission during a connection event. The intended peripheral device 104, 106, 108, 110, 112, and/or 114 may transmit an LL data PDU upon receipt of a packet carrying an LL data PDU from the central device 102. In some other aspects, a peripheral device 104, 106, 108, 110, 112, and/or 114 may transmit an LL data PDU to the central device 102 without first receiving an LL data PDU from the central device 102.

Examples of the central device 102 may include a cellular phone, a smartphone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch or wireless headphones), a vehicle, a vehicle infotainment system or car kit, an electric meter, a gas pump, a toaster, a thermostat, a hearing aid, a blood glucose on-body unit, an Internet-of-Things (IoT) device, or the like.

Examples of the one or more peripheral devices 104, 106, 108, 110, 112, and/or 114 may include a cellular phone, a smartphone, an SIP phone, an STA, a laptop, a PC, a desktop computer, a PDA, a satellite radio, a global positioning system, a multimedia device, a video device, a digital audio player, a camera, a game console, a tablet, a smart device, a wearable device (e.g., a smart watch, wireless headphones, or wireless earbuds), a vehicle, a vehicle infotainment system or car kit, an electric meter, a gas pump, a toaster, a thermostat, a hearing aid, a blood glucose on-body unit, an IoT device, or the like. Although the central device 102 is illustrated in FIG. 1 as being in communication with six peripheral devices 104, 106, 108, 110, 112, and 114 in the WPAN 100, the central device 102 may communicate with more or fewer than six peripheral devices within the WPAN 100 without departing from the scope of the present disclosure.

In some aspects, a device implementing the BT protocol (e.g., the central device 102) may operate according to a first radio mode (e.g., a basic rate (BR)/enhanced data rate (EDR) radio mode), and a device implementing the BLE protocol may operate according to a second radio mode (e.g., the BLE radio mode). In some aspects, the central device 102 may be configured with dual radio modes, and therefore may be able to operate according to the BR/EDR mode or the BLE mode, for example, based on the type of short-range wireless communication in which the central device 102 may engage.

For example, in some aspects, the central device 102 may operate according to the BR/EDR mode for continuous streaming of data, for broadcast networks, for mesh networks, and/or for some other applications in which a relatively higher data rate may be more suitable. Additionally, or alternatively, the central device 102 may operate according to the BLE mode for short burst data transmissions, such as for some other applications in which power conservation may be desirable and/or a relatively lower data rate may be acceptable. Additionally, or alternatively, in some aspects, the central device 102 may operate according to one or more other radio modes, such as proprietary radio mode(s). Examples of other radio modes may include high speed radio modes, low energy radio modes, and/or isochronous radio modes, among other examples.

In some aspects, as described in more detail elsewhere herein, an assisting wireless device (e.g., among peripheral devices 104, 106, 108, 110, 112, and 114) may track a first retransmission metric that is based on a number of retransmitted packets that the assisting wireless device received from a source device, such as the central device 102. The assisting wireless device may receive, from a sink wireless device (e.g., among peripheral devices 104, 106, 108, 110, 112, and 114), an acknowledgement assistance request indicating a second retransmission metric for the sink wireless device. The assisting wireless device may transmit, to the sink wireless device, a response to the acknowledgement assistance request based on respective values of the first retransmission metric and the second retransmission metric. Additionally, or alternatively, the assisting wireless device may perform one or more other operations described herein.

In some aspects, as described in more detail elsewhere herein, a sink wireless device (e.g., among peripheral devices 104, 106, 108, 110, 112, and 114) may track a first retransmission metric that is based on a number of retransmitted packets that the sink wireless device received from a source device, such as the central device 102. The sink wireless device may transmit, to an assisting wireless device (e.g., among peripheral devices 104, 106, 108, 110, 112, and 114), an acknowledgement assistance request indicating the first retransmission metric tracked by the sink wireless device. The sink wireless device may receive, from the assisting wireless device, a response to the acknowledgement assistance request based on respective values of the first retransmission metric tracked by the sink wireless device and a second retransmission metric tracked by the assisting wireless device. Additionally, or alternatively, the sink wireless device may perform one or more other operations described herein.

As indicated above, FIG. 1 is provided as an example. Other examples may differ from what is described with regard to FIG. 1.

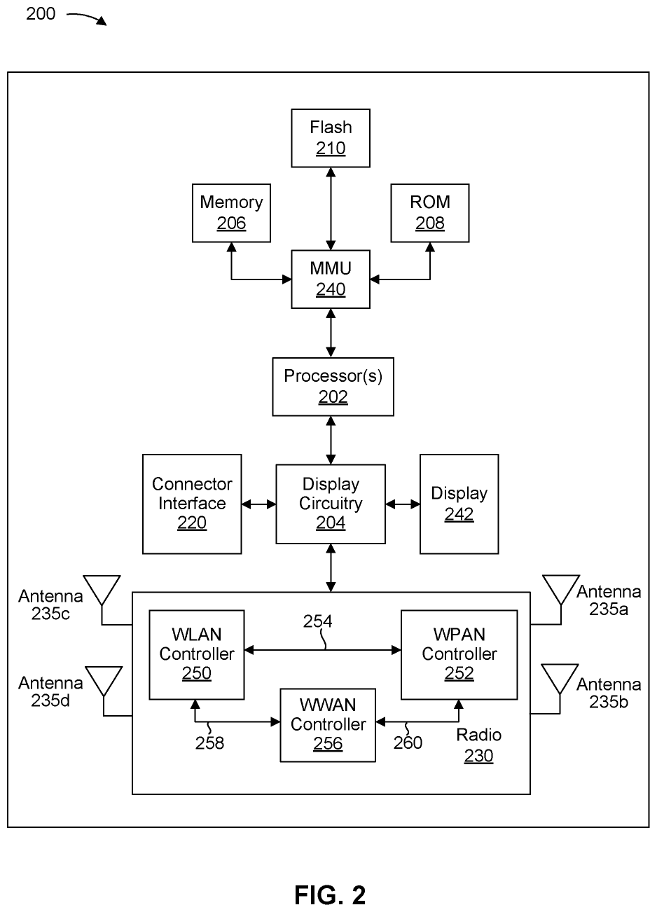

FIG. 2 is a diagram illustrating an example of a wireless communication device 200, in accordance with the present disclosure. In some aspects, the wireless communication device 200 may be an example of the central device 102 illustrated in FIG. 1. Additionally, or alternatively, the wireless communication device 200 may be an example of one or more of the peripheral devices 104, 106, 108, 110, 112, or 114 illustrated in FIG. 1. In some aspects, the wireless communication device 200 may be a Bluetooth-enabled device (such as a BLE device).

As shown in FIG. 2, the wireless communication device 200 may include a processing element, such as processor(s) 202, which may execute program instructions for the wireless communication device 200. The wireless communication device 200 may also include a display 242 that can perform graphics processing and present information to a user. The processor(s) 202 may also be coupled to a memory management unit (MMU) 240, which may be configured to receive addresses from the processor(s) 202 and translate the addresses to address locations in memory such as memory 206, ROM 208, or flash memory 210 and/or to address locations in other circuits or devices, such as display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless communication device 200. For example, the wireless communication device 200 may include various memory types, a connector interface 220 through which the wireless communication device 200 can communicate with a computer system, and wireless communication subsystems that can transmit data to, and receive data from, other devices based on one or more wireless communication standards or protocols. For example, in some aspects, the wireless communication subsystems may include (but are not limited to) a wireless local-area network (WLAN) subsystem, a WPAN subsystem, and/or a cellular subsystem (such as a Long-Term Evolution (LTE) or New Radio (NR) subsystem). The wireless communication device 200 may include multiple antennas 235a, 235b, 235c, and/or 235d for performing wireless communication with, for example, wireless communication devices in a WPAN. In some aspects, the WPAN may be an extended PAN (XPAN).

The wireless communication device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an FPGA, and/or an application specific integrated circuit (ASIC).

In some aspects, the radio 230 may include separate controllers configured to control communications for various respective radio access technology (RAT) protocols. For example, as shown in FIG. 2, radio 230 may include a WLAN controller 250 that manages WLAN communications, a WPAN controller 252 that manages Bluetooth, BLE, and/or other suitable WPAN communications, and a wireless wide area network (WWAN) controller 256 that manages WWAN communications. In some aspects, the wireless communication device 200 may store and execute a WLAN software driver for controlling WLAN operations performed by the WLAN controller 250, a WPAN software driver for controlling WPAN operations performed by the WPAN controller 252, and/or a WWAN software driver for controlling WWAN operations performed by the WWAN controller 256.

In some aspects, a first coexistence interface 254 (such as a wired interface) may be used for sending information between the WLAN controller 250 and the WPAN controller 252. Additionally, or alternatively, in some aspects, a second coexistence interface 258 may be used for sending information between the WLAN controller 250 and the WWAN controller 256. Additionally, or alternatively, in some aspects, a third coexistence interface 260 may be used for sending information between the WPAN controller 252 and the WWAN controller 256.

In some aspects, one or more of the WLAN controller 250, the WPAN controller 252, and/or the WWAN controller 256 may be implemented as hardware, software, firmware, or any suitable combination thereof.

In some aspects, the WLAN controller 250 may be configured to communicate with a second device in a WPAN using a WLAN link using one or more, some, or all of the antennas 235a, 235b, 235c, and 235d. In other configurations, the WPAN controller 252 may be configured to communicate with at least one second device in a WPAN using one or more, some, or all of the antennas 235a, 235b, 235c, and 235d. In other configurations, the WWAN controller 256 may be configured to communicate with a second device in a WPAN using one or more, some, or all of the antennas 235a, 235b, 235c, and 235d. The WLAN controller 250, the WPAN controller 252, and/or the WWAN controller 256 may be configured to adjust a wakeup time interval and a shutdown time for the wireless communication device 200.

A short-range wireless communications protocol, such as BT, BLE, and/or BR/EDR, may include and/or may use one or more other communications protocols, for example, to establish and maintain communications links. Referring also to FIG. 1, the wireless communication device 200 may establish a communications link 116 with one or more peripheral devices, such as a wireless headset 112, according to at least one communications protocol for short-range wireless communications. In some aspects, the communications link 116 may include a communications link that adheres to a protocol included and/or for use with BT, BLE, BR/EDR, or the like. In one aspect, the communications link 116 may include an asynchronous connection-oriented logical (ACL) transport, sometimes referred to as an ACL link. When operating as an ACL link, the communications link 116 may allow the central device 102 (e.g., a source device) to connect or “pair” with a peripheral device, such as the headset 112. The connection is asynchronous in that the two devices may not need to synchronize, timewise, data communications between each other to permit communication of data packets via the communications link 116.

In some aspects, a logical link control and adaptation protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some aspects, the communications link 116 may include an advanced audio distribution profile (A2DP) link. For example, an A2DP link may provide a point-to-point link between a source device, such as the central device 102, and a sink device, such as the headset 112. With an A2DP link, data packets including audio may be transmitted over an ACL channel, and other information (e.g., for controlling the audio stream) may be transmitted over a separate control channel. The data packets may occur non-periodically.

In some aspects, the communications link 116 may support synchronous logical transport mechanisms between a source device (such as the central device 102) and a peripheral device (such as the headset 112). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience.

In some aspects, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link 116 shown in FIG. 1 may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, a peripheral device (e.g., wireless communication device 200, earbud, wearable device, portable speaker) includes means for receiving a signal experiencing interference; and/or means for transmitting a suggestion for an adjustment to transmission of the signal based at least in part on a determination of whether the interference is duty-cycled or saturated. In some aspects, the means for the peripheral device to perform operations described herein may include, for example, one or more of a WPAN controller 252, memory 206, antenna 235, processor 202, and/or MMU 240.

In some aspects, a central device (e.g., wireless communication device 200, mobile station, UE) includes means for receiving a suggestion for an adjustment to transmission of a signal, the suggestion being associated with a determination of whether interference affecting the signal is duty-cycled or saturated; and/or means for applying the adjustment to the transmission of the signal. In some aspects, the means for the central device to perform operations described herein may include, for example, one or more of a WPAN controller 252, memory 206, antenna 235, processor 202, and/or MMU 240.

As indicated above, FIG. 2 is provided as an example. Other examples may differ from what is described with regard to FIG. 2.

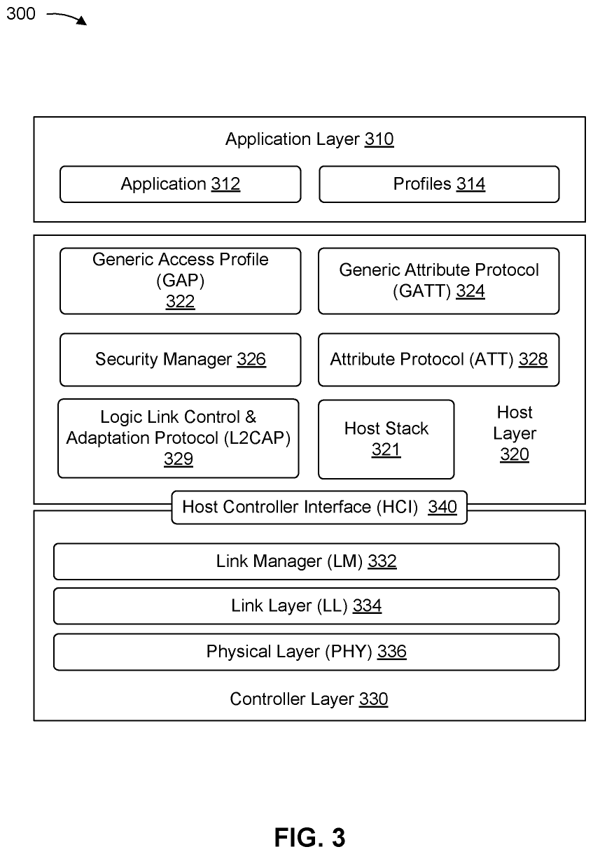

FIG. 3 is a diagram illustrating an example 300 of a protocol stack (e.g., a WPAN and/or a Bluetooth protocol stack), in accordance with the present disclosure. In some aspects, the protocol stack 300 may be implemented in a wireless communication device (such as the central device 102 or one or more of the peripheral devices 104, 106, 108, 110, 112, or 114 of FIG. 1). For example, the protocol stack 300 may be implemented by one or more of processor(s) 202, memory 206, flash memory 210, ROM 208, the radio 230, and/or the WPAN controller 252 illustrated in FIG. 2. In some aspects, the protocol stack 300 may be organized into three layers that include an application layer 310, a host layer 320, and a controller layer 330.

In some aspects, the application layer 310 may be a user application layer that interfaces with the other blocks and/or layers of the protocol stack 300. In some aspects, the application layer 310 may include one or more applications 312 and one or more Bluetooth profiles 314 that allow the one or more applications 312 to use Bluetooth and/or BLE communications. The host layer 320 may include the upper layers of the protocol stack 300, and may communicate with a controller (such as the WPAN controller 252 of FIG. 2) in a wireless communication device using a host controller interface (HCI) 340. In some aspects, the host layer 320 may include a host stack 321 that can be used for application layer interface management to allow an application 312 to access WPAN communications.

The controller layer 330 may include the lower layers of the protocol stack 300. In some aspects, the controller layer 330 may be used for hardware interface management, link establishment, and link management. As shown in FIG. 3, the controller layer 330 may include a link manager (LM) 332, a link layer 334, and a physical (PHY) layer 336. The PHY layer 336 may include, for example, a radio and/or a baseband processor. In some aspects, the PHY layer 336 may define a mechanism for transmitting a bit stream over a physical link or channel that connects WPAN devices. The bit stream may be grouped into code words or symbols, and may be converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a transmitter/receiver (or transceiver) included in a wireless communication device. The physical characteristics may include modulation characteristics, an RF tolerance, and/or a sensitivity level, among other examples.

In some aspects, the link layer 334 is responsible for low-level communication over the PHY layer 336. The link layer 334 may manage the sequence and timing for transmitting and receiving data packets, and using an LL protocol, communicates with other devices regarding connection parameters and data flow control. The link layer 334 also provides gatekeeping functionality to limit exposure and data exchange with other devices. If filtering is configured, the link layer 334 maintains a list of allowed devices and may ignore all requests for data exchange from devices not on the list of allowed devices. The link layer 334 may also reduce power consumption. In some aspects, the link layer 334 may include a proprietary LL that may be used to discover peer devices and establish a secure communication channel with the peer devices. In some aspects, the link layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The link manager 332 may be responsible for establishing and configuring links and managing power-change requests, among other tasks. Each type of logical link, such as ACL links, A2DP links, SCO links, eSCO links, ISO links, or the like, may be associated with a specific packet type. For example, an SCO link may provide reserved channel bandwidth for communication between a central device and a peripheral device, and may support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The link manager 332 may communicate with the host layer 320 using the HCI 340. In some aspects, the link manager 332 may translate commands associated with the HCI 340 into controller-level operations, such as baseband-level operations. The HCI 340 may act as a boundary between the lower layers (such as between the controller layer 330, the host layer 320, and the application layer 310). The BT specification may define a standard HCI to support BT systems that are implemented across two separate processors. For example, a BT system on a computer may use a processor of the BT system to implement the lower layers of the protocol stack 300, such as the PHY layer 336, the link layer 334, and/or the link manager 332, and may use a processor of a BT component to implement the other layers of the protocol stack 300, such as the host layer 320 and the application layer 310.

In FIG. 3, the host layer 320 is shown to include a generic access profile (GAP) 322, a generic attribute protocol (GATT) 324, a security manager (SM) 326, an attribute protocol (ATT) 328, and an L2CAP layer 329. The GAP 322 may provide an interface for an application 312 to initiate, establish, and manage connections with other WPAN (e.g., BT or BLE) devices. The GATT 324 may provide a service framework using the attribute protocol for discovering services, and for reading and writing characteristic values on a peer device. The GATT 324 may interface with the application 312, for example, through a profile which may define a collection of attributes and any permissions needed for the attributes to be used in BT or BLE communications.

The security manager 326 may be responsible for device pairing and key distribution. A security manager protocol implemented by the security manager 326 may define how communications with the security manager of a counterpart BLE device are performed. The security manager 326 provides additional cryptographic functions that may be used by other components of the protocol stack 300. The architecture of the security manager 326 used in WPAN communications is designed to minimize recourse requirements for peripheral devices by shifting work to a presumably more powerful central device. BLE uses a pairing mechanism for key distribution. The security manager 326 provides a mechanism to encrypt the data and a mechanism to provide data authentication.

The ATT 328 includes a client/server protocol based on attributes associated with a BLE device configured for a particular purpose. Examples may include monitoring heart rate, temperature, broadcasting advertisements, or the like. The attributes may be discovered, read, and written by peer devices. The set of operations which are executed over the ATT 328 may include error handling, server configuration, find information, read operations, write operations, and/or queued writes. The ATT 328 may form the basis of data exchange between BT and BLE devices.

The L2CAP layer 329 may be implemented above the HCI 340, and may communicate with the controller layer 330 through the HCI 340. The L2CAP layer 329 may be responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven (27) bytes) on the transmit side.

In some standards and protocols, such as BLE and/or BR/EDR, the central device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet, and failure of MIC validation may indicate that another packet has not been received (although failure of CRC validation may also indicate that another packet has not been received, and/or failure of MIC validation may also indicate one or more errors in a received packet).

CRC validation and MIC validation may be based on generating CRC values and MICs, respectively, based on received packets and respectively comparing those generated CRC values and MICs to CRC values and MICs included in the received packets. Specifically, a receiving device, such as the headset 112, that receives a packet may first generate a CRC value or a CRC checksum based on the received packet, such as based on a payload and, if applicable, an MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines that the received packet fails CRC validation, then the received packet may include errors and/or may be corrupted. In one configuration, the receiving device may discard the received packet that fails CRC validation. Alternatively, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate an MIC based on the decrypted payload and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation. Alternatively, in another configuration, the receiving device may attempt to recover the received packet.

As indicated above, FIG. 3 is provided as an example. Other examples may differ from what is described with regard to FIG. 3.

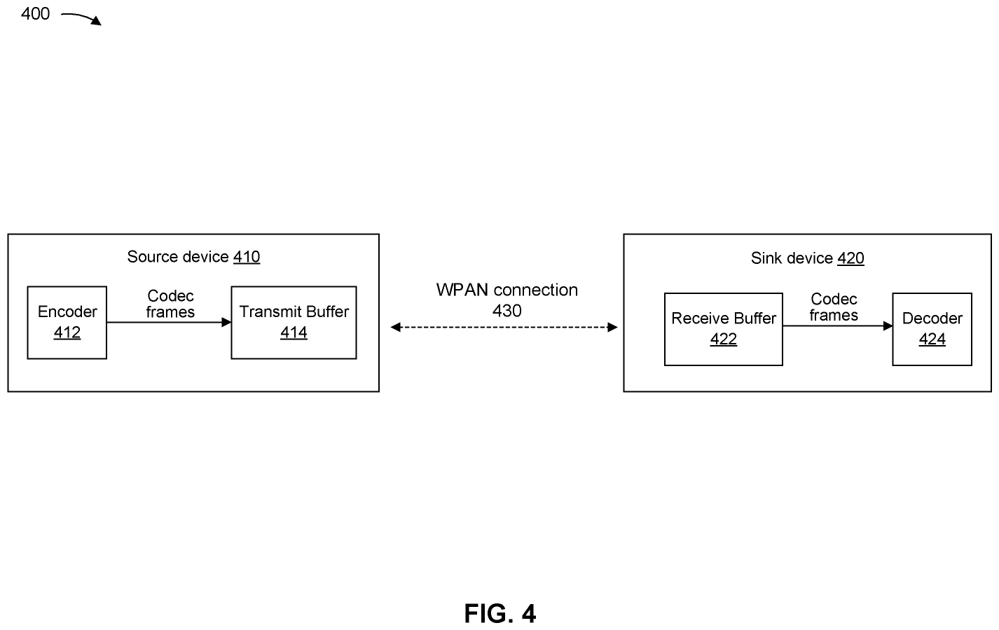

FIG. 4 is a diagram illustrating an example transmission 400 of a data packet from a source device 410 to a sink device 420 over a WPAN connection 430, according to the present disclosure. In some aspects, the source device 410 may be one example of the central device 102 in FIG. 1 and/or the wireless communication device 200 in FIG. 2, and the sink device 420 may be an example of one or more of the peripheral devices 104, 106, 108, 110, 112 or 114 in FIG. 1. In some aspects, the sink device 420 may be a wireless earbud, a pair of wireless earbuds, a wireless portable speaker, or another suitable device. The WPAN connection 430 may be any suitable Bluetooth or BLE connection or link. In some instances, the WPAN connection 430 may be one or more of an ACL link, an L2CAP link, an A2DP link, an SCO link, or an ISO link.

As shown in FIG. 4, the source device 410 may include an encoder 412 and a transmit buffer 414. The encoder 412 may be configured to encode data, such as audio or video data, using a specified bitrate. The transmit buffer 414 may be configured to queue data packets that are to be transmitted over the WPAN connection 430 to the sink device 420. In some implementations, the data packets to be transmitted over the WPAN connection 430 may have a predefined size, for example, based on the type of WPAN connection 430 and/or channel conditions associated with the WPAN connection 430. In some aspects, data encoded by the encoder 412 may be packetized into a data packet of a predefined size. The source device 410 may de-queue data packets from the transmit buffer 414 and transmit the data packets to the sink device 420 over the WPAN connection 430.

As further shown in FIG. 4, the sink device 420 may include a receive buffer 422 and a decoder 424. Data packets that the sink device 420 receives over the WPAN connection 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate and forward the first codec frame to the transmit buffer 414 to be packetized for transmission to the sink device 420 over the WPAN connection 430. The sink device 420 may queue the received data packet in the receive buffer 422 and may forward the first portion of the first codec frame to the decoder 424 for decoding.

As indicated above, FIG. 4 is provided as an example. Other examples may differ from what is described with regard to FIG. 4.

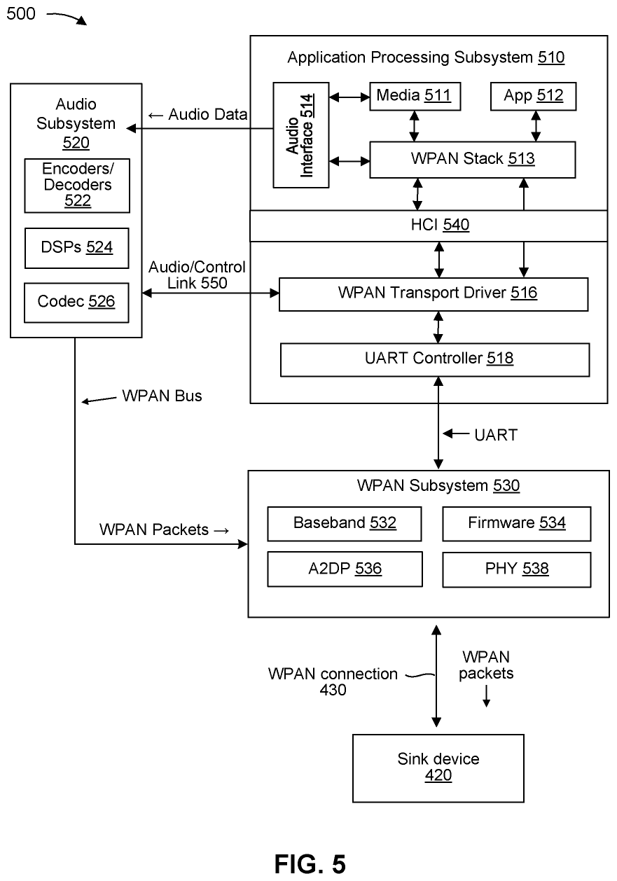

FIG. 5 is a diagram illustrating an example 500 of a wireless communication device 500, according to the present disclosure. In some aspects, the wireless communication device 500 may be an example of the central device 102 in FIG. 1, the wireless communication device 200 in FIG. 2, or the source device 410 in FIG. 4. In example 500, the wireless communication device 500 is depicted as having an established WPAN connection 430 (e.g., a Bluetooth communication connection) with the sink device 420 in FIG. 4.

The wireless communication device 500 may include an application processing subsystem 510, an audio subsystem 520, a WPAN subsystem 530, and an HCI 540. The application processing subsystem 510, which may correspond to at least some portions of the application layer 310 and the host layer 320 of the protocol stack 300 of FIG. 3, is shown to include a media player 511, an application layer 512, a WPAN stack 513, and an audio interface 514. The media player 511 can be any suitable device or component capable of generating or receiving multimedia content including, for example, real-time audio streams, real-time video streams, real-time gaming streams, and/or latency-sensitive traffic, among other examples. The application layer 512, which may be one implementation of the application layer 310 of FIG. 3, includes at least one Bluetooth profile that defines the collection of attributes and associated permissions to be used in Bluetooth or BLE communications. In some aspects, the application layer 512 may include processing resources including, for example, the memory 206, the ROM 208, and/or the flash memory 210 of FIG. 2. The WPAN stack 513 may be one implementation of the protocol stack 300 of FIG. 3.

In some aspects, as shown in FIG. 5, the application processing subsystem 510 may include a WPAN transport driver 516, which may include a split audio and packetization module (not shown for simplicity) that can packetize data (such as audio and/or video data) into Bluetooth frames that can be transmitted to the sink device 420 using a Bluetooth and/or BLE protocol. In some aspects, the WPAN transport driver 516 may be connected to the audio subsystem 520 via an audio and control link 550. In some aspects, the audio and control link 550 may be used to send encoded audio/video data and control signals between the WPAN transport driver 516 and audio/video DSPs within the audio subsystem 520. The WPAN transport driver 516 is also connected to a universal asynchronous receiver-transmitter (UART) controller 518 that provides controls for transmission of information via the WPAN connection 430.

The audio subsystem 520 may include encoders/decoders 522, one or more DSPs 524, and one or more codecs 526. The encoders/decoders 522 may be used to sample audio/video data extracted from one or more packets received from another wireless communication device. The extracted audio/video data may be processed in the application processing subsystem 510 based at least in part on the Bluetooth profile. In some implementations, the encoders/decoders 522 may partition the sampled audio/video data into payloads that can be embedded within one or more Bluetooth packets for transmission to the sink device 420 over the WPAN connection 430. In some instances, the DSPs 524 and/or the codecs 526 may employ one or more encoding or decoding algorithms in conjunction with sampling the audio data.

The WPAN subsystem 530 may include a baseband component 532 (e.g., a Bluetooth baseband component), a firmware component 534, an A2DP component 536, and a PHY component 538. The baseband component 532 and the firmware component 534 may be used to generate baseband signals for constructing and deconstructing data frames based on the Bluetooth or BLE protocol. The baseband component 532 and the firmware component 534 may also be used to generate carrier signals for up-converting baseband signals during data transmissions and for down-converting received data signals to baseband. The A2DP component 536 may be used to control or manage an A2DP link between the wireless communication device 500 and the sink device 420. Specifically, when the WPAN subsystem 530 is in a receive mode, the PHY component 538 can be used to receive, demodulate, and down-convert data packets received over the WPAN connection 430, and to forward the data packets to the application processing subsystem 510. When the WPAN subsystem 530 is in a transmit mode, the PHY component 538 can be used to encapsulate data provided from the upper layers into one or more Bluetooth frames or packets for transmission to the sink device 420 over the WPAN connection 430.

Communications may be target wake time (TWT)-based with synchronized end-to-end (E2E) timing. TWT involves the use of a schedule for waking up to communicate and powering down to conserve power.

As indicated above, FIG. 5 is provided as an example. Other examples may differ from what is described with regard to FIG. 5.

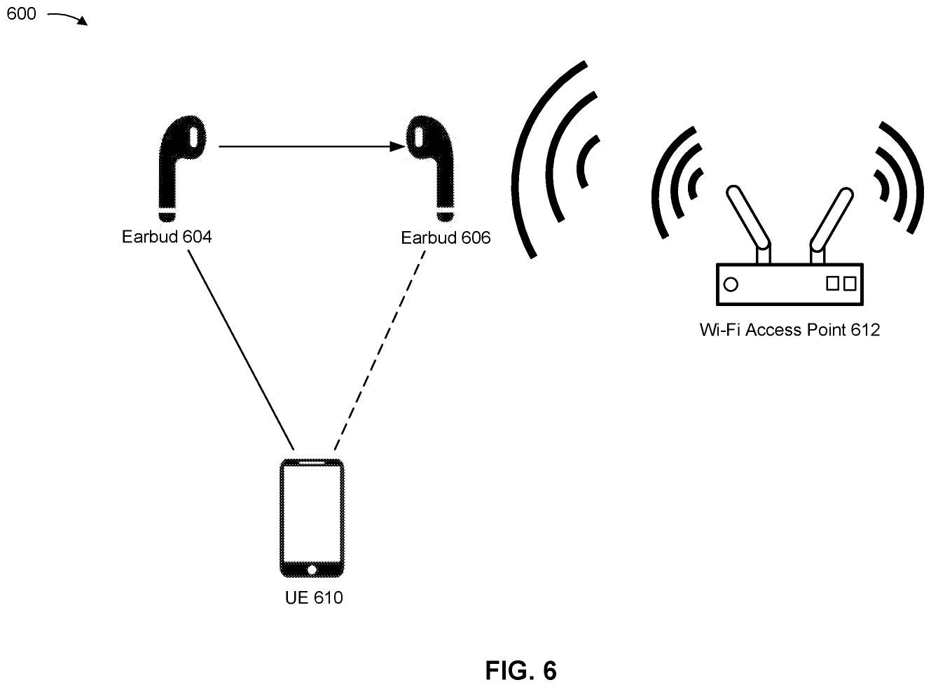

FIG. 6 is a diagram illustrating an example 600 of audio streams, in accordance with the present disclosure. Example 600 shows a UE 610 that operates with a first earbud 604 (e.g., peripheral device 110) and a second earbud 606 (e.g., peripheral device 110) that are paired together. UE 610 may support a peripheral link, such as a basic rate (BR)/enhanced data rate (EDR) Bluetooth® audio link (BREDR), a BLE link, an A2DP link, or a proprietary link with the first earbud 604 and/or the second earbud 606.

When UE 610 operates with the pair of earbuds 604 and 606, earbud 604 takes on a primary role (P-bud), and earbud 606 takes on a secondary role (S-bud). Note that either earbud may take on the primary role or the secondary role. Earbud 604, as a primary earbud in the primary role, may connect to UE 610 over a peripheral link (e.g., relay piconet), such as an A2DP link. Earbud 604 may connect to earbud 606 over a selective relay link. Earbud 606, as a secondary earbud in the secondary role, may sniff the link between UE 610 and earbud 604 to receive packets that use an audio/video distribution transport protocol (AVDTP) or an eSCO protocol. Earbud 604 and earbud 606 may use the relay piconet between them to relay voice data or microphone data. Earbud 606, in the secondary role, may not connect to UE 610 on a peripheral link. In some designs, earbud 604 may relay, to earbud 606, all of the audio data packets, or all of the audio data packets that pertain to earbud 606 (e.g., right audio or left audio).

However, the links may suffer interference in some frequency spectrums from other devices, such as a Wi-Fi access point 612, that are in proximity to the earbuds. The expectation is to have minimum BT Audio glitches when performing Wi-Fi tests with moderate Wi-Fi traffic (not a 100% saturated Wi-Fi environment). A Wi-Fi test may involve a user with earbuds walking toward a Wi-Fi interference setup and observing the point from where the glitches happen systematically. Designs and deployments seek the least possible BT Audio glitches with a certain interference proximity in a very saturated Wi-Fi test. One of the most common factors that leaves BT Audio (A2DP) susceptible to 2.4 GHz Wi-Fi interference is the packet type selected for media packets. Earbuds are always the sink of A2DP Audio and are responsible for indicating the preference of BT packets to the central device/audio source via a CQDDR scheme.

As part of the CQDDR scheme, the packet size is selected by RSSI over the BT network according to channel conditions. To be precise, an LMP_preferred_rate is sent from time to time to indicate the preference of BT packets sent to the sink device. Some peripheral devices start with a preference of 3 Mbps and request to switch to 3-DH3 if a PER (Packet Error Rate) increases. The first 3 in 3-DH3 indicates an enhanced data rate 3 Mbps modulation, and the second 3 indicates that the packet is in 3 time slots. The peripheral devices may then request to switch to 2-DH5 (2 Mbps with 5 time slots) and finally to 2-DH3 (2 Mbps with 2 time slots) when the PER is at its peak. 2 Mbps modulation is better than 3 Mbps for interference susceptibility. Some peripheral devices may request that the central device remain with 2-DH5 packets as 2-DH5 may be the best choice. A common rule is that as PER increases further, there is a shift from 3-DH5=>3-DH3=>2-DH5=>2-DH3 (2-DH1 will not be used in streaming).

Generally, maximum transmission unit (MTU) sizes selected for A2DP streaming may include either 672 octets or 895 octets (depending on the codec and preference from the earbuds). In an example, 895 octets may be assumed. When channel conditions start to degrade the CQDDR, the peripheral device may request a 2 Mbps preference, such as 2-DH5+2-DH3 packet=˜895 octet MTU. There may be some inefficiency because transmissions are using 10 slots instead of 6 slots (plus any overhead for retransmissions). At some point in time, the environment may be completely saturated with interference, and the CQDDR selection may involve a request for a 3 slot packet. This causes the central device to move down to 3 slot packets. Finally, the whole 895 octet L2CAP may be divided into 3 baseband packets of 2-DH3 each (2-DH3+2-DH3+2-DH3). This may be more inefficient because the transmissions are using 12 slots.

One issue is not the use of 10 slots or 12 slots but the effort required to transmit a single fragmented media packet through the interference (or to complete an L2CAP that is fragmented). In an almost saturated Wi-Fi environment, a single packet may take 50-60 ms to be successfully transmitted because of retransmissions. Whether the transmitter uses 2-DH5 or 2-DH3 does not matter as much beyond a certain level of interference.

As indicated above, FIG. 6 is provided as an example. Other examples may differ from what is described with regard to FIG. 6.

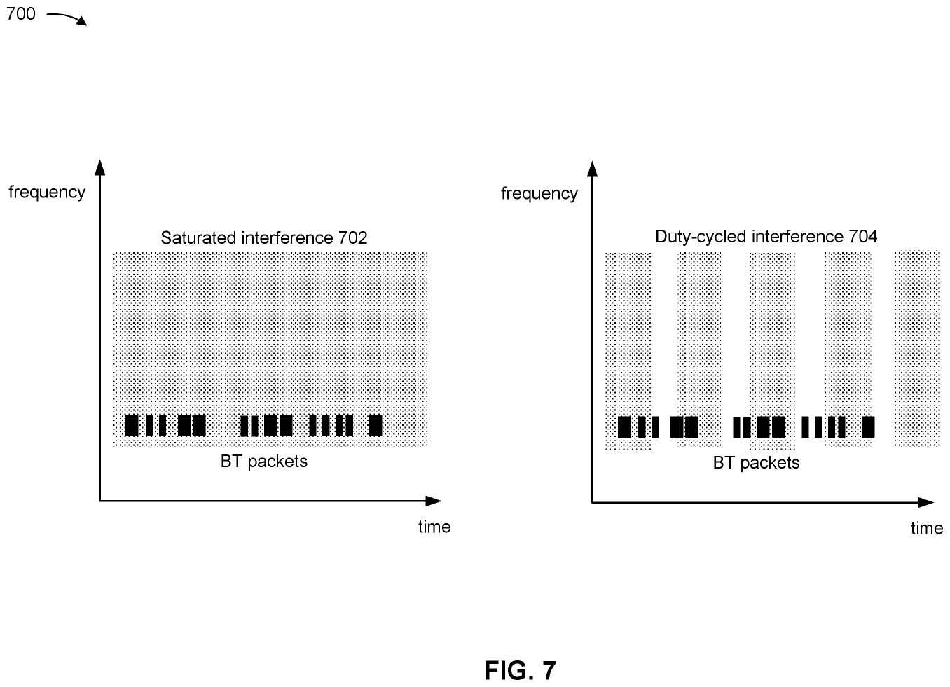

FIG. 7 is a diagram illustrating an example 700 of types of interference, in accordance with the present disclosure.

In a scenario where a receiving peripheral device is to receive 3 packets before the audio subsystem at the peripheral device starts to use the packets, each packet may take a different amount of time to arrive on the BT channel. This increases latency and causes glitches. The situation may be slightly better if the central device is using 2-DH5+2-DH3 instead of 2-DH3+2-DH3+2-DH3. However, saturated interference beyond a certain level affects both long and short packets equally. For example, regardless of whether a packet is 3 slots or 5 slots, almost everything is being retransmitted, as the whole spectrum is being occupied by the saturated interference. Example 700 shows saturated interference 702 that is affecting almost all BT packets.

There is a scenario in which the Wi-Fi interference is not saturated but is duty-cycled (Wi-Fi traffic is moderate). It may be beneficial to use smaller packets (e.g., 2-DH3+2-DH3+2-DH3) in such a scenario, because the smaller packets may have a better chance than longer packets of passing through the duty-cycled interference. Example 700 shows duty-cycled interference 704, where smaller packets may be passing through more easily. Generally, CQDDR algorithms in a BT controller may evaluate the PER for a particular modulation scheme but may not look at the PER for a given length.

As indicated above, FIG. 7 is provided as an example. Other examples may differ from what is described with regard to FIG. 7.

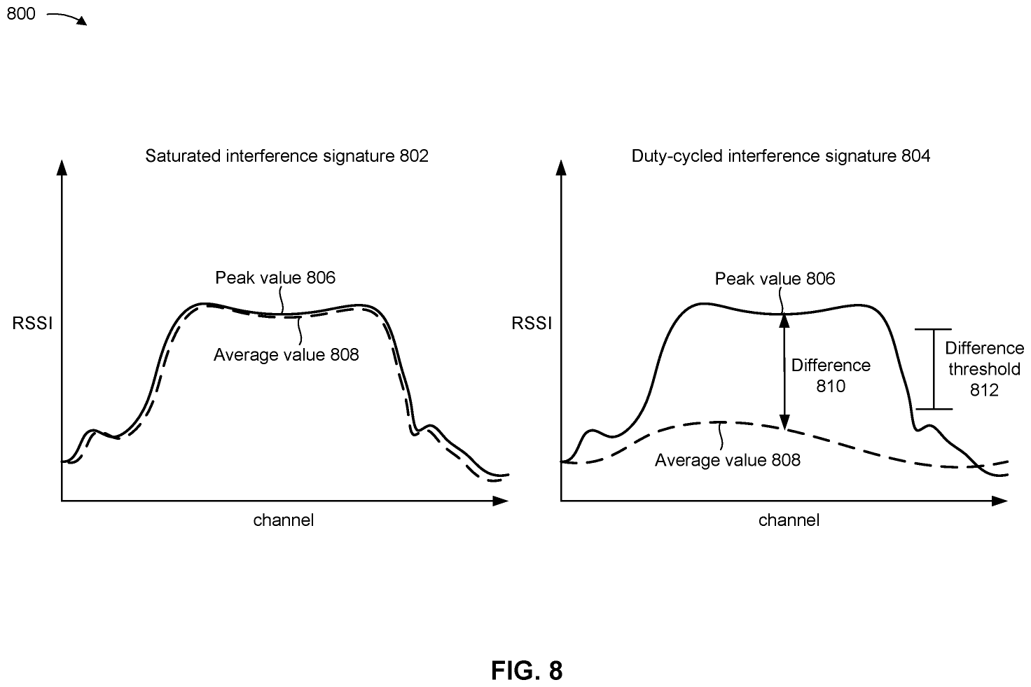

FIG. 8 is a diagram illustrating an example 800 of interference differentiation, in accordance with the present disclosure.

According to some various embodiments described herein, a peripheral device may differentiate between saturated interference and duty-cycled interference for better packet selection. The peripheral device may receive a signal experiencing interference and determine whether the interference is saturated or duty-cycled. The peripheral device may transmit a suggestion to a central device for an adjustment to the transmission based at least in part on the determination. By differentiating between saturated interference and duty-cycled interference, the peripheral device may suggest an adjustment to transmission of the signal that improves throughput.

In an example, the peripheral device may differentiate between saturated interference and duty-cycled interference by identifying a difference between a peak value (peak RSSI value) and an average value (average RSSI value) of measurements of the signal. As shown by the saturated interference signature 802 in example 800, the peak value 806 and the average value 808 of RSSI match, or nearly match, for saturated interference. By contrast, as shown by the duty-cycled interference signature 804 in example 800, there is a significant difference 810 between the peak value 806 and the average value 808 of RSSI. The difference 810 may vary depending on the duty percentage of the duty cycle, where a greater duty (amount of time out of the total time) corresponds to a greater average value. The peripheral device may determine that the interference is duty-cycled if the difference 810 satisfies a difference threshold 812 (e.g., minimum RSSI value difference) at a specific point, a highest point, or at any point. Because duty-cycled interference is at a certain level for part of the time and well below that level for another part of the time, the average value is lower over time. The peripheral device may determine that the interference is saturated if the difference 810 does not satisfy the difference threshold.

In some aspects, the difference and the difference threshold may be evaluated in other ways. For example, the peripheral device may compare the average value 808 to a threshold distance from 0. The interference may be saturated if the average value 808 is above a certain value. As the average value 808 is relative to the peak value 806, a difference may be implied, and the threshold distance may reflect a difference threshold.

The peripheral device may suggest an adjustment based at least in part on the determination. In some aspects, if the interference is duty-cycled, the peripheral device may suggest an adjustment (e.g., using standard BT CQDDR) of a smaller packet size (e.g., 5 slots to 3 slots), a larger packet size (to reduce overhead in saturated interference), or an adjustment to a higher or lower modulation. The adjustment may be applicable to QHS while selecting between QHS-5 to QHS-2 (a longer packet with more robustness versus a short packet with less robustness). The peripheral device may select channels with a minimum duty cycle over an equivalent low power high duty cycle, thereby reducing the probability of retransmission. In some aspects, the peripheral device may benefit from hardware that is capable of obtaining parallel RSSI measurements, where parallel measurement allows for an easy detection of wide band interference across multiple channels.

As indicated above, FIG. 8 is provided as an example. Other examples may differ from what is described with regard to FIG. 8.

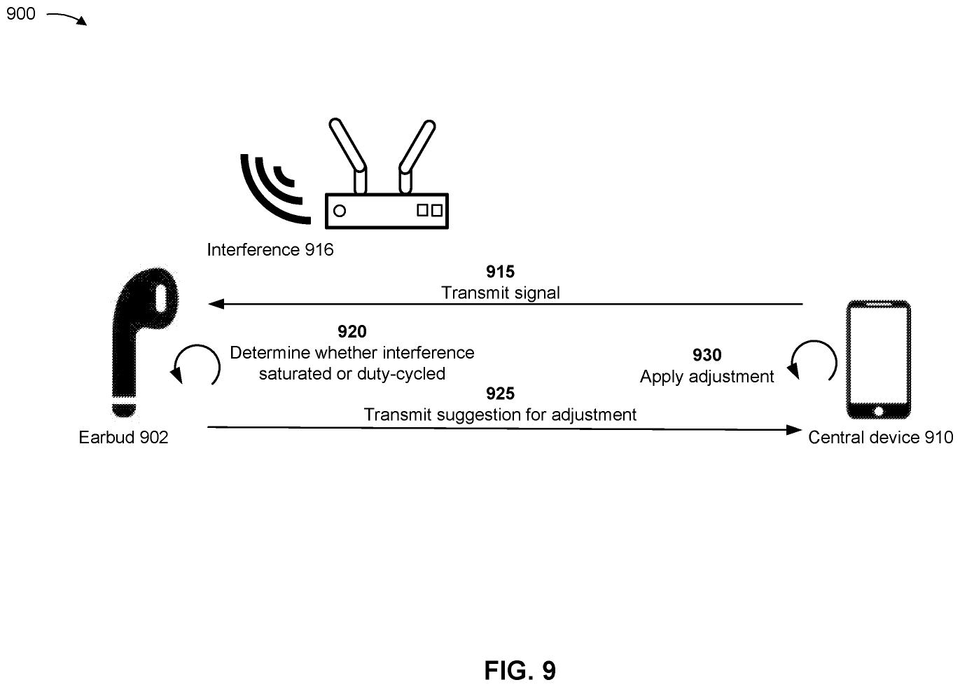

FIG. 9 is a diagram illustrating an example 900 of making an adjustment based on differentiating types of interference, in accordance with the present disclosure. Earbud 902 (e.g., wireless communication device 200, peripheral device, primary earbud, owner earbud) may communicate with a paired earbud and a central device (e.g., a wireless communication device 200, a UE, a phone).

As shown by reference number 915, the central device 910 may transmit a signal. The signal may include BT packets. The signal may experience interference 916 from a nearby Wi-Fi signal source.

As shown by reference number 920, the earbud 902 may determine whether the interference 916 is saturated or duty-cycled by comparing a difference between an RSSI peak value and an RSSI average value to a difference threshold. The earbud 902 may select or be configured with a quantity of measurements to take over a period of time. The measurements may hop frequencies, such that measurements are obtained at different frequencies of a target frequency bandwidth.

The earbud 902 may determine an adjustment that can be made to transmission of the signal. For example, the earbud 902 may select a packet size or quantity to be used for transmission of the signal. The earbud 902 may change an enhanced date rate packet format (e.g., 2-DH5 to 2-DH3 or QHS-2). The adjustments may be made in either direction (larger packet for saturation determination or shorter packet for duty-cycle determination). The adjustment may be to refrain from fragmenting packets to a short length. The adjustment may be to change a modulation for the transmission of the signal (e.g., 3-DH3 to 2-DH3). As shown by reference number 925, the earbud 902 may transmit a suggestion for the adjustment.

As shown by reference number 930, the central device 910 may apply the adjustment. For example, the central device 910 may change the packet size or modulation based at least in part on the suggested adjustment. In some aspects, the adjustment may have a time duration for which the adjustment is to be applied before reverting back to a previous transmission setting.

By differentiating interference, the peripheral device may make suggestions for transmission adjustments to improve a balance of throughput, signal resource conservation, and latency.

As indicated above, FIG. 9 is provided as an example. Other examples may differ from what is described with regard to FIG. 9.

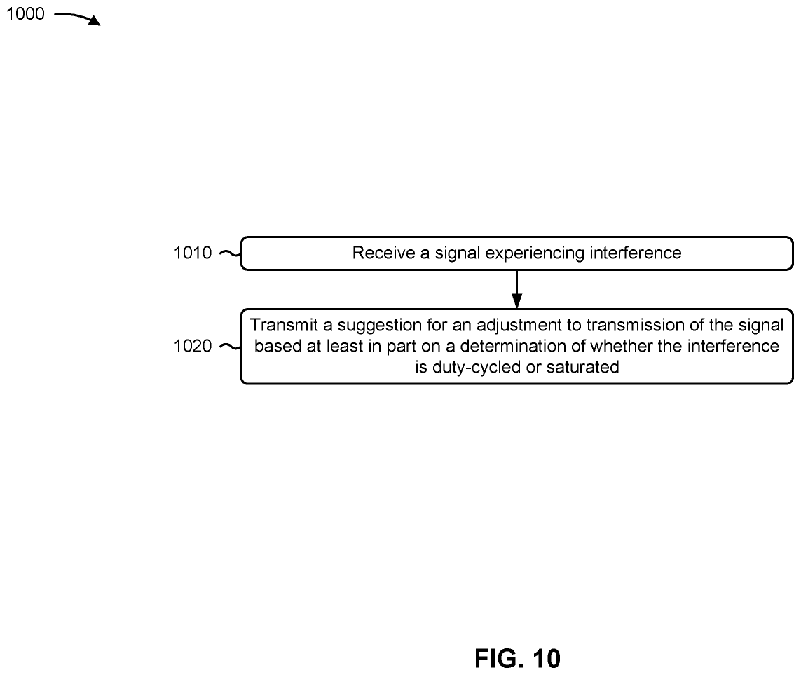

FIG. 10 is a diagram illustrating an example process 1000 performed, for example, at a peripheral device or an apparatus of a peripheral device, in accordance with the present disclosure. Example process 1000 is an example where the apparatus or the peripheral device (e.g., (e.g., wireless communication device 200, earbud 902)]) performs operations associated with interference differentiation.

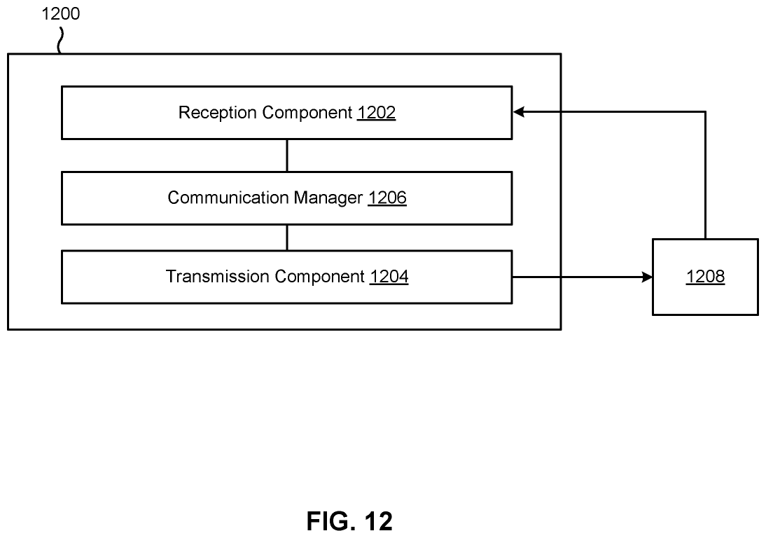

As shown in FIG. 10, in some aspects, process 1000 may include receiving a signal experiencing interference (block 1010). For example, the peripheral device (e.g., using reception component 1202 and/or communication manager 1206, depicted in FIG. 12) may receive a signal experiencing interference, as described above.

As further shown in FIG. 10, in some aspects, process 1000 may include transmitting a suggestion for an adjustment to transmission of the signal based at least in part on a determination of whether the interference is duty-cycled or saturated (block 1020). For example, the peripheral device (e.g., using transmission component 1204 and/or communication manager 1206, depicted in FIG. 12) may transmit a suggestion for an adjustment to transmission of the signal based at least in part on a determination of whether the interference is duty-cycled or saturated, as described above.

Process 1000 may include additional aspects, such as any single aspect or any combination of aspects described below and/or in connection with one or more other processes described elsewhere herein.

In a first aspect, the determination is based at least in part on a difference between a peak value of an RSSI of the signal and an average value of the RSSI.

In a second aspect, alone or in combination with the first aspect, the determination is that the interference is saturated, based at least in part on the difference satisfying a difference threshold, or that the interference is duty-cycled, based at least in part on the difference not satisfying a difference threshold.

In a third aspect, alone or in combination with one or more of the first and second aspects, the adjustment is to change a packet size or quantity used for the transmission of the signal.

In a fourth aspect, alone or in combination with one or more of the first through third aspects, the adjustment is to change an enhanced data rate packet format used for the transmission of the signal.

In a fifth aspect, alone or in combination with one or more of the first through fourth aspects, the adjustment is to refrain from fragmenting packets to a shorter length for the transmission of the signal.

In a sixth aspect, alone or in combination with one or more of the first through fifth aspects, the adjustment is to change a modulation for the transmission of the signal.

In a seventh aspect, alone or in combination with one or more of the first through sixth aspects, process 1000 includes selecting a quantity of measurements for the determination.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

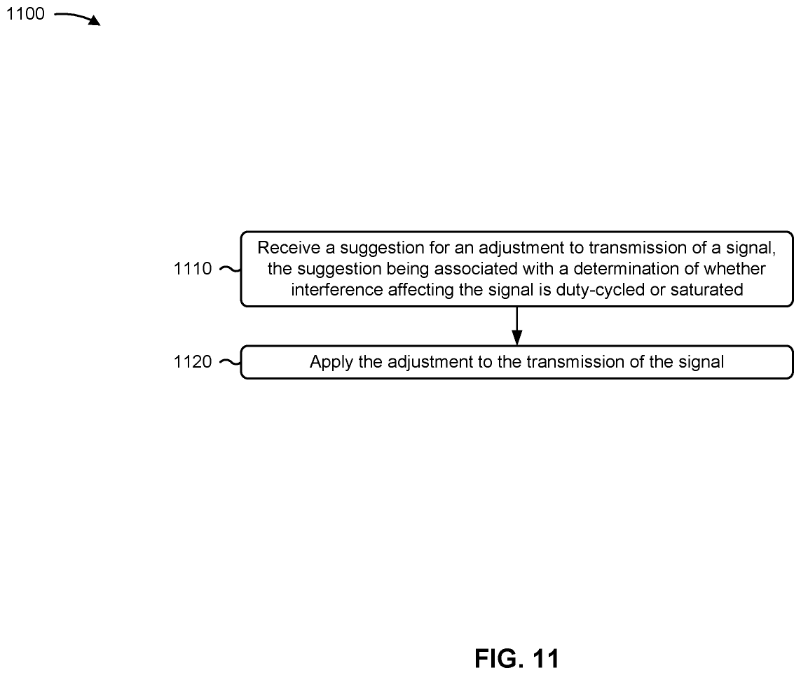

FIG. 11 is a diagram illustrating an example process 1100 performed, for example, at a central device or an apparatus of a central device, in accordance with the present disclosure. Example process 1100 is an example where the apparatus or the central device (e.g., wireless communication device 200, central device 910) performs operations associated with interference differentiation.

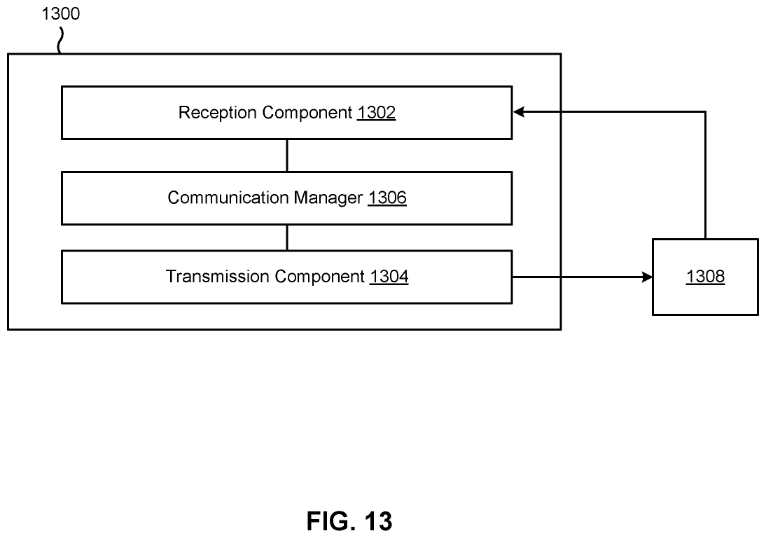

As shown in FIG. 11, in some aspects, process 1100 may include receiving a suggestion for an adjustment to transmission of a signal, the suggestion being associated with a determination of whether interference affecting the signal is duty-cycled or saturated (block 1110). For example, the central device (e.g., using reception component 1302 and/or communication manager 1306, depicted in FIG. 13) may receive a suggestion for an adjustment to transmission of a signal, the suggestion being associated with a determination of whether interference affecting the signal is duty-cycled or saturated, as described above.

As further shown in FIG. 11, in some aspects, process 1100 may include applying the adjustment to the transmission of the signal (block 1120). For example, the central device (e.g., using communication manager 1306, depicted in FIG. 13) may apply the adjustment to the transmission of the signal, as described above.

Process 1100 may include additional aspects, such as any single aspect or any combination of aspects described below and/or in connection with one or more other processes described elsewhere herein.

In a first aspect, the adjustment is to change a packet size or quantity used for the transmission of the signal.

In a second aspect, alone or in combination with the first aspect, the adjustment is to change an enhanced data rate packet format used for the transmission of the signal.

In a third aspect, alone or in combination with one or more of the first and second aspects, the adjustment is to refrain from fragmenting packets to a shorter length for the transmission of the signal.

In a fourth aspect, alone or in combination with one or more of the first through third aspects, the adjustment is to change a modulation for the transmission of the signal.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a peripheral device, or a peripheral device may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the WPAN controller 252 described in connection with FIG. 2. As shown, the apparatus 1200 may communicate with another apparatus 1208, such as a central device, using the reception component 1202 and the transmission component 1204.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the peripheral device described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more receive processors, one or more controllers/processors, one or more memories, or a combination thereof, of the peripheral device described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit processors, one or more controllers/processors, one or more memories, or a combination thereof, of the peripheral device described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a signal experiencing interference. The transmission component 1204 may transmit a suggestion for an adjustment to transmission of the signal based at least in part on a determination of whether the interference is duty-cycled or saturated. The communication manager 1206 may select a quantity of measurements for the determination.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a central device, or a central device may include the apparatus 1300. In some aspects, the apparatus 1300 includes a reception component 1302, a transmission component 1304, and/or a communication manager 1306, which may be in communication with one another (for example, via one or more buses and/or one or more other components).

In some aspects, the communication manager 1306 is the communication manager WPAN controller 252 described in connection with FIG. 1. As shown, the apparatus 1300 may communicate with another apparatus 1308, such as a peripheral device, a UE, or a network node (such as a central unit (CU), a distributed unit (DU), a radio unit (RU), or a base station), using the reception component 1302 and the transmission component 1304.

In some aspects, the apparatus 1300 may be configured to perform one or more operations described herein in connection with FIGS. 1-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the central device described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more multiple-input multiple output (MIMO) detectors, one or more receive processors, one or more controllers/processors, one or more memories, or a combination thereof, of the central device described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the central device described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a suggestion for an adjustment to transmission of a signal, the suggestion being associated with a determination of whether interference affecting the signal is duty-cycled or saturated. The communication manager 1306 may apply the adjustment to the transmission of the signal.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a peripheral device, comprising: receiving a signal experiencing interference; and transmitting a suggestion for an adjustment to transmission of the signal based at least in part on a determination of whether the interference is duty-cycled or saturated.

Aspect 2: The method of Aspect 1, wherein the determination is based at least in part on a difference between a peak value of a received signal strength indicator (RSSI) of the signal and an average value of the RSSI.

Aspect 3: The method of Aspect 2, wherein the determination is that the interference is saturated, based at least in part on the difference satisfying a difference threshold, or that the interference is duty-cycled, based at least in part on the difference not satisfying a difference threshold.

Aspect 4: The method of any of Aspects 1-3, wherein the adjustment is to change a packet size or quantity used for the transmission of the signal.

Aspect 5: The method of any of Aspects 1-4, wherein the adjustment is to change an enhanced data rate packet format used for the transmission of the signal.

Aspect 6: The method of any of Aspects 1-5, wherein the adjustment is to refrain from fragmenting packets to a shorter length for the transmission of the signal.

Aspect 7: The method of any of Aspects 1-6, wherein the adjustment is to change a modulation for the transmission of the signal.

Aspect 8: The method of any of Aspects 1-7, further comprising selecting a quantity of measurements for the determination.

Aspect 9: A method of wireless communication performed by a central device, comprising: receiving a suggestion for an adjustment to transmission of a signal, the suggestion being associated with a determination of whether interference affecting the signal is duty-cycled or saturated; and applying the adjustment to the transmission of the signal.

Aspect 10: The method of Aspect 9, wherein the adjustment is to change a packet size or quantity used for the transmission of the signal.

Aspect 11: The method of any of Aspects 9-10, wherein the adjustment is to change an enhanced data rate packet format used for the transmission of the signal.

Aspect 12: The method of any of Aspects 9-11, wherein the adjustment is to refrain from fragmenting packets to a shorter length for the transmission of the signal.

Aspect 13: The method of any of Aspects 9-12, wherein the adjustment is to change a modulation for the transmission of the signal.

Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 15: An apparatus for wireless communication at a device, the apparatus comprising one or more memories and one or more processors coupled to the one or more memories, the one or more processors configured to cause the device to perform the method of one or more of Aspects 1-13.

Aspect 16: An apparatus for wireless communication, the apparatus comprising at least one means for performing the method of one or more of Aspects 1-13.

Aspect 17: A non-transitory computer-readable medium storing code for wireless communication, the code comprising instructions executable by one or more processors to perform the method of one or more of Aspects 1-13.

Aspect 18: A non-transitory computer-readable medium storing a set of instructions for wireless communication, the set of instructions comprising one or more instructions that, when executed by one or more processors of a device, cause the device to perform the method of one or more of Aspects 1-13.

Aspect 19: A device for wireless communication, the device comprising a processing system that includes one or more processors and one or more memories coupled with the one or more processors, the processing system configured to cause the device to perform the method of one or more of Aspects 1-13.

Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a peripheral device, comprising:
one or more memories; and
one or more processors, coupled to the one or more memories, individually or collectively configured to cause the peripheral device to:
receive a signal experiencing interference; and
transmit a suggestion for an adjustment to transmission of the signal based at least in part on a determination of whether the interference is duty-cycled or saturated.

2. The apparatus of claim 1, wherein the determination is based at least in part on a difference between a peak value of a received signal strength indicator (RSSI) of the signal and an average value of the RSSI.

3. The apparatus of claim 2, wherein the determination is that the interference is saturated, based at least in part on the difference satisfying a difference threshold, or that the interference is duty-cycled, based at least in part on the difference not satisfying a difference threshold.

4. The apparatus of claim 1, wherein the one or more processors are individually or collectively configured to cause the peripheral device to change a packet size or quantity used for the transmission of the signal.

5. The apparatus of claim 1, wherein the one or more processors are individually or collectively configured to cause the peripheral device to change an enhanced data rate packet format used for the transmission of the signal.

6. The apparatus of claim 1, wherein the one or more processors are individually or collectively configured to cause the peripheral device to refrain from fragmenting packets to a shorter length for the transmission of the signal.

7. The apparatus of claim 1, wherein the one or more processors are individually or collectively configured to cause the peripheral device to change a modulation for the transmission of the signal.

8. The apparatus of claim 1, wherein the one or more processors are individually or collectively configured to cause the peripheral device to select a quantity of measurements for the determination.

9. An apparatus for wireless communication at a central device, comprising:
one or more memories; and
one or more processors, coupled to the one or more memories, individually or collectively configured to cause the central device to:
receive a suggestion for an adjustment to transmission of a signal, the suggestion being associated with a determination of whether interference affecting the signal is duty-cycled or saturated; and
apply the adjustment to the transmission of the signal.

10. The apparatus of claim 9, wherein the one or more processors are individually or collectively configured to cause the central device to change a packet size or quantity used for the transmission of the signal.

11. The apparatus of claim 9, wherein the one or more processors are individually or collectively configured to cause the central device to change an enhanced data rate packet format used for the transmission of the signal.

12. The apparatus of claim 9, wherein the one or more processors are individually or collectively configured to cause the central device to refrain from fragmenting packets to a shorter length for the transmission of the signal.

13. The apparatus of claim 9, wherein the one or more processors are individually or collectively configured to cause the central device to change a modulation for the transmission of the signal.

14. A method of wireless communication performed by a peripheral device, comprising:
receiving a signal experiencing interference; and
transmitting a suggestion for an adjustment to transmission of the signal based at least in part on a determination of whether the interference is duty-cycled or saturated.

15. The method of claim 14, wherein the determination is based at least in part on a difference between a peak value of a received signal strength indicator (RSSI) of the signal and an average value of the RSSI.

16. The method of claim 15, wherein the determination is that the interference is saturated, based at least in part on the difference satisfying a difference threshold, or that the interference is duty-cycled, based at least in part on the difference not satisfying a difference threshold.

17. The method of claim 14, wherein the adjustment is to change a packet size or quantity used for the transmission of the signal.

18. The method of claim 14, wherein the adjustment is to change an enhanced data rate packet format used for the transmission of the signal.

19. The method of claim 14, wherein the adjustment is to refrain from fragmenting packets to a shorter length for the transmission of the signal.

20. The method of claim 14, wherein the adjustment is to change a modulation for the transmission of the signal.
